(19) United States
(12) Patent Application Publication
(10) Pub. No.: US 2007/0202408 A1
(43) Pub. Date: Aug. 30, 2007

(54) Non-aqueous electrolyte secondary battery, negative electrode thereof, and method for manufacturing negative electrode

(76) Inventors: Shinji Nakanishi, Shizuoka (JP); Hizuru Koshina, Palo Alto, CA (US); Hiroshi Yoshizawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/709,797

(22) Filed: Feb. 23, 2007

(30) Foreign Application Priority Data
Feb. 24, 2006 (JP) 2006-048219

(51) Int. Cl. H01M 4/40; H01M 4/58

(52) U.S. Cl. 429/231.9; 429/231.6; 429/231.95; 29/623.5

(57) ABSTRACT

A negative electrode for a non-aqueous electrolyte secondary battery includes a current collector, a first layer and a second layer. The first layer is provided on the current collector and includes at least any one of alkaline metals and alkaline earth metals. The second layer is provided on the first layer, and includes an active material capable of absorbing and desorbing lithium ions having a barrier function of blocking ingress of gas.

### BACKGROUND OF THE INVENTION

1. Field of the Invention

The present invention relates to a negative electrode for a non-aqueous electrolyte secondary battery and a method for manufacturing the same. More particularly, the present invention relates to a structure of a negative electrode.

2. Background Art

A lithium ion secondary battery, a lithium ion polymer secondary battery, and the like, have high energy densities which conventional secondary batteries such as a lead storage battery, a nickel-cadmium storage battery, and a nickel hydrogen storage battery have never achieved. Therefore, these secondary batteries have been used as a driving power source of information portable equipment and audio visual equipment.

For an active material of a negative electrode of these secondary batteries, kinds of carbon materials absorbing and desorbing lithium ions have been used. Examples of the carbon materials include artificial graphite, natural graphite, heat treated meso-phase products formed from coal/petroleum pitch, non-graphitizable carbons obtained by heat treating coal/petroleum pitch to which oxygen was introduced, and non-graphitizable carbons made from heat treated plastic product which originally contained oxygen. An average potential at which a graphite material releases lithium ions is about 0.2 V, which is cathodic as compared with than that of non-graphitizable carbon, and the potential change in accordance with the progress of discharge is small. Therefore, in fields desiring high voltage and voltage flatness, graphite materials are mainly used as an active material of a negative electrode. However, capacity per unit volume of the graphite material is so small as 838 mAh/cm³ and this capacity is not desired to be further increased from the viewpoint of its crystalline structure.

On the other hand, as the active material of a negative electrode having a high capacity density, a material forming an intermetallic compound with lithium, for example, silicon (Si), tin (Sn), or the like, is promising. However, these materials change their crystalline structures and expand when they store lithium ions. Therefore, particles may be crumbled or detached from a current collector, so that the charge/discharge cycle lifetime is short. Furthermore, the crumbling of particles increases reaction with an electrolyte and causes film formation and the like so as to increase the interface resistance. This phenomenon is also a cause of shortening the charge/discharge cycle lifetime.

Furthermore, oxides of Group 13, 14, and 15 elements in the periodic table, for example, silicon monoxide (SiO), tin monoxide (SnO), and the like, are considered as active materials of a negative electrode. For example, Japanese Patent Unexamined Publication No. 2001-220124 discloses a method of coating a mixture including particulate silicon monoxide or tin monoxide and a binder on a current collector.

However, since silicon oxide much expands and shrinks during charging/discharging similar to the case where Si, Sn, or an intermetallic compound thereof is used as the active material, the charge/discharge cycle lifetime is short. Furthermore, when a material such as SiO or SnO is used as an active material of the negative electrode of a lithium battery, a large amount of electricity is needed for the initial charging and a part of the capacity required for the initial charging (irreversible capacity) is not used for the later electrochemical reaction. When the irreversible capacity is large, excessive active materials of positive electrode the capacity corresponding to that of the initial storing are needed when a battery is designed. Therefore, battery capacity per unit volume or battery capacity per unit weight becomes lower.

As a method for reducing this irreversible capacity, for example, Japanese Patent Unexamined Publication No. 5-144472 discloses a method of attaching a lithium metal on a part of a negative electrode or a method of attaching a lithium foil on the outermost surface of the negative electrode.

However, even if the irreversible capacity is reduced by such methods, the cycle characteristic and the like is not different from the case where lithium is not attached. Furthermore, since the lithium metal is exposed on the outermost surface of the negative electrode, the negative electrode must be always treated under an environment at a low dew point.

### SUMMARY OF THE INVENTION

A negative electrode for a non-aqueous electrolyte secondary battery of the present invention includes a current collector, a first layer and a second layer. The first layer is provided on the current collector and formed of at least any one of alkaline metals and alkaline earth metals. The second layer is provided on the first layer. The second layer has a barrier function of blocking ingress of gas and is formed of an active material capable of absorbing and desorbing lithium ions.

### BRIEF DESCRIPTION OF THE DRAWINGS

FIG. 1 is a longitudinal sectional view showing a coin-shaped model cell for evaluating a negative electrode for a non-aqueous electrolyte secondary battery in accordance with an embodiment of the present invention.

FIG. 2 is an exploded perspective view showing a flat type non-aqueous electrolyte secondary battery in accordance with the embodiment of the present invention.

### DETAILED DESCRIPTION OF THE INVENTION

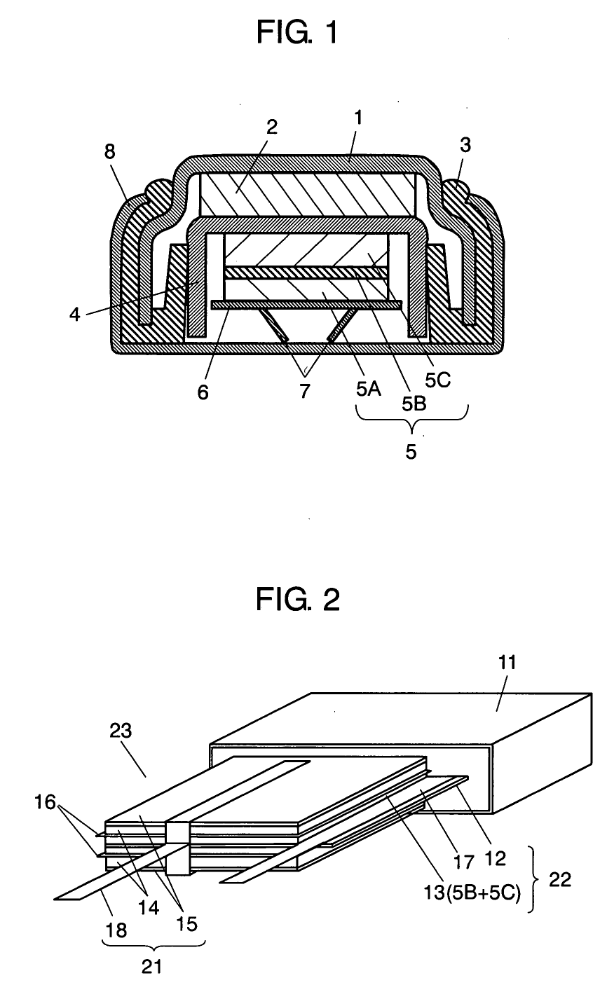

FIG. 1 is a longitudinal sectional view showing a coin-shaped model cell for evaluating a negative electrode for a non-aqueous electrolyte secondary battery in accordance with an embodiment of the present invention.

Lithium electrode 2 as a counter electrode and test electrode 5, facing each other, are disposed with separator 4 sandwiched therebetween. Lithium electrode 2 and test electrode 5 are pressed to case 1 by stainless steel (SUS) plate 6 and coned disc spring 7 made of SUS. Case 1 and case 8 are combined with each other via gasket 3 so as to seal lithium electrode 2, test electrode 5 and separator 4. Separator 4 is impregnated with electrolyte solution that is a non-aqueous electrolyte (not shown).

The electrolyte solution is prepared, for example, by dissolving lithium hexafluorophosphate (LiPF₆) into a solvent containing ethylene carbonate (EC) having high-permittivity and at least one chain carbonates with low viscosity such as diethyl carbonate (DEC), dimethyl carbonate (DMC), and ethyl methyl carbonate (EMC). Alternatively, gel polymer electrolytes with lithium ion conductivity using such electrolyte solutions as a plasticizer may be used.

Test electrode 5 that is a negative electrode includes current collector 5A, first layer 5B and second layer 5C in a state before the electrolyte solution is introduced. First layer 5B is provided on current collector 5A. First layer 5B is formed of at least any one of alkaline metals and alkaline earth metals. Second layer 5C is provided on first layer 5B. Second layer 5C has a barrier function of blocking ingress of gas and is formed of an active material absorbing and desorbing lithium ions.

A material of current collector 5A is not particularly limited. Metallic foil or a resin core material whose surface is covered with a metal is used. Metallic foil as current collector 5A is not particularly limited as long as it has enough conductivity. Typical examples of the metallic foil include at least one metal or two or more metals or an alloy the metals selected from the group consisting of platinum, gold, silver, copper, iron, nickel, zinc, aluminum, titanium, chromium, and indium. The resin core material used for current collector 5A is not particularly limited. Examples of the resin core material include at least one or more resin selected from polyethylene terephthalate (PET), polycarbonate, aramid resin, polyimide resin, phenol resin, polyether sulphone resin, polyether ketone resin, polyamide resin, and the like. For the purpose of improving the tensile strength, a filler such as polyethylene, polystyrene, silica, and alumina may be mixed in the above-mentioned resin. It is preferable that the strength of the resin core material is 20 MPa or more. On this resin core material, at least one or more thin films of a transition metal such as gold, silver, copper, iron, and nickel, zinc, aluminum, and the like, is formed by, for example, vapor deposition non-electrolytic plating so as to produce current collector 5A.

Examples of an alkaline metal or an alkaline earth metal constituting first layer 5B can include Li, Na, K, Mg, Sr, Ca and Ba. These are formed on the entire surface of current collector 5A so as to form first layer 5B. However, the entire surface herein may not necessarily be limited to completely entire surface. First layer 5B may be formed with a minute pinhole or a small missing part on the end. First layer 5B may be provided in a way in which it is slightly smaller so that it is reliably covered with second layer 5C.

First layer 5B can be formed by, for example, vapor deposition. Since an amount (volume) of an alkaline metal or an alkaline earth metal necessary to reduce the irreversible capacity of active materials constituting second layer 5C is extremely small, it is difficult to produce metallic foil. Therefore, it is preferable to employ a gas phase method such as vapor deposition.

Second layer 5C can be formed by a powder mixture layer or a layer without containing an organic binder of a simple substance, an alloy, or a mixture of carbon materials or Group 13, 14, and 15 elements in the periodic table capable of absorbing and desorbing lithium ions, as long as the above-mentioned conditions are satisfied. Note here that examples of the carbon material can include at least one or more materials selected from the group consisting of artificial graphite, natural graphite, heat treated meso-phase products formed from coal/petroleum pitch, non-graphitizable carbons obtained by heat treating coal/petroleum pitch to which oxygen was introduced, and non-graphitizable carbons made from heat treated plastic product which orginally contained oxygen, and the like. Furthermore, as a layer of an alloy or a mixture of Group 13, 14, and 15 elements in the periodic table capable of absorbing and desorbing lithium ions, for example, a layer of an alloy of one selected from the group consisting of Si, Sn, Ge, In and Pb and one selected from the group consisting of Ti, Fe, Ni, V, Co, Cu, Mn, Zr, Y, Nb, Mg, La, Hf and Ta may be contained as a main component.

Other than oxides of Si or Sn, materials that are oxides of Group 13, 14, and 15 elements in the periodic table and capable of absorbing and desorbing lithium ions can be used for second layer 5C. It can be thought that examples of such oxides include oxides of Ge, Pb, Sb, and Bi. These oxides can form second layer 5C without using an organic binder. As a method for forming second layer 5C, mainly, a physical vapor deposition such as vacuum deposition by resistance heating, induction heating, and an electron beam method, sputtering, laser ablation, and a spraying method; and a chemical vapor deposition method such as CVD and plasma CVD, can be employed. In particular, a vacuum deposition method by an electron beam heating is advantageous in actual production because the film formation rate is increased.

Furthermore, it is preferable that second layer 5C is continuously formed after first layer 5B is formed in a way in which an oxidizing atmosphere is avoided. Thus, since first layer 5B is not oxidized, when a battery is constructed and the negative electrode is brought into contact with a non-aqueous electrolyte, first layer 5B is efficiently reacted with second layer 5C.

Furthermore, as a raw material of oxides forming second layer 5C, other than the same material as the oxide, a mixture of a simple substance and a higher order oxide may be used. For example, when a SiO layer is formed, SiO or a mixture of Si and SiO₂ may be used as a raw material.

Furthermore, these oxides may contain oxide as a principal component and a part thereof may be a metal or an alloy. For example, the principal component is SiOₓ or SnOₓ and partially Si or Sn may be mixed. Such a mixture can be produced by the method and conditions of film formation. In this case, in the entire active material, the composition ratio of oxygen becomes small. In particular, in a preferable mixture with SiO, the atom ratio of oxygen is smaller than that of silicon. Furthermore, an oxide whose number of oxygen atoms inevitably generated in production is changed may be included. Furthermore, impurities may be contained for inevitable reasons in production. Such a case is also effective. It is thought that examples of such impurities include metal, non-metal and oxides thereof.

It is preferable that second layer 5C includes a simple substance, a compound or a mixture of Group 13, 14, and 15 elements in the periodic table as a main component. Among them, it is particularly preferable that second layer 5C includes a simple substance or a compound of silicon or tin or a mixture thereof. When an electrolyte solution is introduced, a chemical reaction occurs between an alkaline metal or an alkaline earth metal constituting first layer 5B and second layer 5C. For example, it is estimated that when first layer 5B is formed of lithium and second layer 5C is formed of silicon oxide, the reaction represented by the following expression (1) is caused.

2xLi+SiO_{y}→xLi₂O+SiO_{y-x} (1)

When the amount of an alkaline metal or an alkaline earth metal is controlled to be an amount corresponding to the irreversible capacity, the alkaline metal or the alkaline earth metal reacts with second layer 5C so as to be ionized and absorbed by second layer 5C. FIG. 1 shows a state before such a reaction occurs. After the reaction, when charging is carried out, the difference between the charged capacity and discharged capacity at the first cycle (the difference is regarded as irreversible capacity) becomes extremely small as compared with the case where first layer 5B is not provided.

Furthermore, when first layer 5B is formed on current collector 5A, the retention rate of discharge capacity after a predetermined number of times of charges and discharges are repeated (hereinafter, referred to as a capacity retention rate) is improved. Hereinafter, the reason why the capacity retention rate is improved is described.

One reason is thought to be because there is a different in the process of consuming the amount corresponding to the irreversible capacity. That is to say, when the irreversible capacity is electrochemically treated by the first charge as a conventional method, second layer 5C expands. In the case where first layer 5B formed of an alkaline metal or an alkaline earth metal is brought into contact with second layer 5C so as to consume the amount corresponding to the irreversible reaction amount, second layer 5C also expands. However, it is estimated that a structure is not easily broken microscopically and the density is maintained. As a result, even when charges and discharges are repeated and second layer 5C repeats expansion and shrinkage, it is estimated that the difference of the first structure affects the cycle performance.

By attaching an alkaline metal on a part of second layer 5C, the amount of the irreversible capacity can be consumed. However, the consumption of the amount of the irreversible reaction is different depending upon places of second layer 5C. That is to say, in the vicinity of the attached alkaline metal, the alkaline metal is consumed in an amount of the irreversible reaction or more. Meanwhile, in a place distant from the attached alkaline metal, the alkaline metal is consumed in an amount less than the irreversible reaction. Therefore, depending upon the places of second layer 5C, unevenness in extent of reaction occurs. As a result, the degree of expansion by the reaction with the alkaline metal is somewhat different depending upon places of second layer 5C. This expansion unevenness causes variations in the distance between electrodes, thus lowering the cycle performance.

Another reason is thought to be because there is a difference in adhesion between current collector 5A and second layer 5C. After the reaction represented by the expression (1) occurs, second layer 5B on the current collector 5A is completely lost or mostly lost. At this time, simultaneously, second layer 5C expands and the adhesion between current collector 5A and second layer 5C is maintained. Since the adhesion degree between current collector 5A and second layer 5C at this time is excellent, even if a charge/discharge cycle is repeated, it is thought that second layer 5C is not detached from current collector 5A and that the conductivity between current collector 5A and second layer 5C is maintained. Thus, it is thought that an 1excellent cycle performance is shown. That is to say, it is thought that such an effect can be obtained by providing relatively soft second layer 5B of an alkaline metal or an alkaline earth metal on current collector 5A.

Furthermore, according to the configuration of this embodiment, an amount of gas generated at the initial charging is reduced. Although the cause of this reduction has not been clarified in detail, it is thought to be because there is a difference in the process of consuming the amount of the irreversible capacity.

As compared with the amount of gas generated on the surface of the negative electrode by the method of electrochemically treating the amount of the irreversible capacity by the initial charge, an amount of gas generated by slowly consuming the amount of the irreversible reaction by bringing second layer 5B into contact with second layer 5C is extremely small. It is thought that the difference of the amount of gas generated at the time of treating the irreversible capacity is observed as a difference in the amount of gas generated at the initial charge.

Furthermore, when an alkaline metal is attached to a part of second layer 5C, as mentioned above, depending upon the positions of second layer 5C, the degree of expansion slightly differs. As a result, the amount of gas generated at the initial charge is larger than that of this embodiment.

The alkaline metal or the alkaline earth metal used for first layer 5B may include not only lithium but also potassium, sodium, calcium, magnesium, strontium, and barium. Such metals can react with the active material of the negative electrode included in second layer 5C by providing an appropriate heat (temperature) depending upon time or case in the presence of electrolyte solution. For example, when the active material of the negative electrode is silicon oxide or tin oxide, they react with the above-mentioned materials so as to produce potassium oxide, sodium oxide, or the like. Thus, even if alkaline metals or alkaline earth metals other than lithium is used for first layer 5B, the effect of suppressing the irreversible capacity can be achieved. Even when a battery is constructed by using the alkaline metal or alkaline earth metal other than lithium, the entire performance of the battery such as a cycle performance is not affected.

In addition, it is extremely preferable in producing a negative electrode that second layer 5C formed on first layer 5B has a barrier function of blocking ingress of gas. An alkaline metal or an alkaline earth metal is unstable in the normal air and easily reacts with moisture in the air, so that the surface thereof is covered with hydroxide, and the like. Therefore, after first layer 5B is formed, when it is exposed to the normal air, an electrically-insulating layer of hydroxide is formed. Consequently, the resistance of the negative electrode is increased and the cycle performance of charge/discharge of the battery is extremely deteriorated. Therefore, it is necessary to treat first layer 5B in the atmosphere at a low dew point (−20° C. RT or lower) even before a battery is constructed. Therefore, the working efficiency is extremely low and a facility for keeping the atmosphere at a low dew point is needed.

In this embodiment, second layer 5C provided on first layer 5B has a barrier function. Therefore, since working can be carried out under less strict dew-point management, the working efficiency is improved and a facility can be simplified.

Silicon oxide or tin oxide does not easily allow oxygen or water to pass through, so that it has a high barrier property. Therefore, by providing secondary layer 5C including such oxides on first layer 5B, the reaction with moisture in the air is suppressed. Therefore, also at the normal dew point, the resistance of the negative electrode is not increased.

As mentioned above, by using the negative electrode according to this embodiment, it is possible to reduce large irreversible capacity at the initial charge. Furthermore, the amount of gas generated during the initial charge is reduced. In addition, the reduction of discharge capacity can be suppressed even if charge and discharge is repeated.

Next, the advantage of this embodiment is described with reference to specific examples. Note here that the present invention is not limited to the following examples.

Note that the thickness described in the following examples employs the average thickness when the cross section of each layer is observed by using a scanning electron microscope. Strictly, variations in the thickness are generated due to, for example, the shape of the surface. Such variations do not matter in this embodiment.

Firstly, in order to clarify the effect of suppressing the irreversible capacity, a coin-shaped model cell shown in FIG. 1 is produced and evaluated. Firstly, a method of producing a model cell of Example 1 is described.

(i) Production of Lithium Electrode

Lithium foil having a thickness of 200 μm is punched in an inner diameter of 19 mm and used as lithium electrode 2.

(ii) Production of Test Electrode

Copper foil having a length of 50 mm, a width of 50 mm and a thickness of 30 μm is set in a vacuum heating vapor deposition device and vapor deposition is repeated several times until the film thickness becomes 6.5 μm. The vapor deposition is carried out using lithium foil as a vapor deposition source in a state in which the chamber inside is made vacuum to 1×10⁻⁴ torr or less. The vapor deposition is carried out at the vapor deposition rate of 1.5 nm/sec to 3.5 nm/sec for consecutive vapor deposition time of 10 minutes or less. This conditions may be varied depending upon the degree of vacuum or an amount of current to be passed for heating raw materials. Next, the vapor deposition source is replaced by silicon monoxide (SiO) powder and then vapor deposition is carried out several times until the film thickness reaches 10 μm. The vapor deposition is carried out at the vapor deposition rate of 0.55 nm/sec to 1.1 nm/sec for consecutive vapor deposition time of 30 minutes to one hour. A substrate on which the copper foil is set is cooled so that it does not become 200° C. or higher. This film is punched by using a die having an inner diameter of 12 mm and the punched film is used as test electrode 5. That is to say, current collector 5A is formed of copper, first layer 5B is formed of lithium and second layer 5C is formed of SiO.

The number of oxygen (x) in SiOₓ constituting the produced second layer 5C need not be exactly one and may be varied in accordance with the conditions and devices for producing a film. Furthermore, an impure phase may be present or the surface of SiO may be partially oxidized further depending upon the conditions or method at the time of film formation.

(iii) Production of Model Cell

Firstly, lithium electrode 2 is pressed to case 1 so as to be attached thereon. Then, gasket 3 is placed in case 1.

On the other hand, coned disc spring 7 made of stainless steel is spot-welded on case 8 and stainless steel plate 6 having an outer diameter of 17 mm and thickness of 0.2 mm is further spot-welded and fixed on spring 7. These are washed and then, test electrode 5 is disposed in the vicinity of the center on plate 6. Meanwhile, separator 4 made of polypropylene porous film having a thickness of 25 μm and an outer diameter of 19 mm is immersed in an electrolyte solution. Note here that LiPF₆ is dissolved in a solvent obtained by mixing EC and EMC at the volume ratio of 1:3 so as to obtain a solution having a concentration 1 mol/l and the obtained solution is used as an electrolyte solution.

Then, separator 4 is disposed on test electrode 5, so that case 1 and case 8 are combined in a manner that lithium electrode 2 and test electrode 5 are laminated with separator 4 sandwiched therebetween. In this state, case 8 is caulked. Thus, a model cell of Example 1 is completed. The obtained model cell has a dimension of diameter of 20 mm and a total height of about 16 mm.

(iv) Evaluation of Model Cell

Firstly, after the model cell is constructed, it is stored at room temperature for 72 hours to 144 hours until the battery voltage become stable. In the test electrode including metallic lithium, the voltage once reduces to around 0 V. However, then, the voltage is gradually increased and becomes stable. Herein, the model cell is stored at room temperature. However, if the model cell is stored at higher temperature, the reaction is promoted and the voltage becomes constant for a shorter time. The preferable temperature is 80° C. or lower. A temperature of higher than 80° C. may promote decomposition of the electrolyte solution, and may deteriorate the battery performance.

After the voltage is stable, the model cell is transferred to an environment at an ambient temperature of 20° C. Lithium electrode 2 is used for a positive electrode and test electrode 5 is used for a negative electrode, and then discharging is carried out at 61 μA (current density: 0.05 mA/cm²) and to 0 V. Thus, SiO in test electrode 5 is allowed to store lithium ions. After halting for one hour, charging is carried out at a constant current of 61 μA up to 1 V. Thus, SiO in test electrode 5 is allowed to release lithium ions. Such charging/discharging is repeated three times. At this time, a value obtained by dividing the first discharge capacity by charging capacity is defined as an initial charge/discharge efficiency.

In order to make a comparison with the model cell of Example 1, model cells of Comparative Examples 1 and 2 are produced by the following procedure. For Comparative Example 1, a model cell is produced in the same manner as for Example 1 except that in production of test electrode 5, lithium is not vapor deposited but SiO is vapor deposited on copper foil by the same method as in Example 1, and thus second layer 5C is formed on current collector 5A without forming first layer 5B. For Comparative Example 2, in the production of test electrode 5, SiO is vapor deposited on copper foil by the same method as for Example 1 and lithium is further vapor deposited on the vapor deposited SiO by the same method as in Example 1. Thus, the SiO layer is formed on current collector 5A and the lithium layer is formed thereon.

(v) Evaluation of Moisture Resistance of Negative Electrode

Next, the behavior of test electrode 5 is examined when it is exposed to the normal dew point. After test electrode 5 is produced as mentioned above, test electrode 5 is left at an ambient temperature of 25° C. at humidity of 55% for three hours. A model cell is produced by the same method as mentioned above by using test electrode 5 that has been left. Then, similar to the above, the initial charge/discharge efficiency is evaluated. The parameters and evaluation results of the model cells are shown in table 1.

TABLE 1

| | | | | | charge/ | charge/discharge |
|---|---|---|---|---|---|---|
| | first layer | | second layer | | discharge | efficiency with |
| | | thickness | | thickness | efficiency | exposed negative |
| | material | (μm) | material | (μm) | (%) | electrode (%) |
| Example 1 | Li | 6.5 | SiO | 10 | 98.9 | 98.5 |
| Comparative | — | — | SiO | 10 | 65.9 | 66.0 |
| Example 1 | | | | | | |
| Comparative | SiO | 10 | Li | 6.5 | 98.9 | — |
| Example 2 | | | | | | |

In Example 1 and Comparative Example 2 as compared with Comparative Example 1, the charge/discharge efficiency in the first cycle is particularly improved. This is because a lithium layer is formed on a test electrode, so that the irreversible capacity of SiO is compensated. When test electrode 5 that has been left in high humidity conditions is used, the charge/discharge efficiency is the same as that of test electrode 5 that has not been left in high humidity conditions in Example 1 and Comparative Example 1. Also thereafter, the excellent charge/discharge characteristics are observed. On the contrary, in Comparative Example 2, charging and discharging cannot be carried out. Test electrode 5 is observed in high humidity conditions. During the observation, the surface changes its color in 30 minutes or less and reacts with moisture in the air. Thus, it is estimated that the surface of test electrode 5 is covered with insulating substances and the resistance of test electrode 5 is extremely increased, disenabling a current to flow.

Next, the application in an actual battery is investigated.

(vi) Production of Battery

FIG. 2 is a longitudinal sectional view showing a flat type non-aqueous electrolyte secondary battery produced in the examples. This battery is produced as following:

A paste including 100 parts by weight of LiCoO₂ as an active material, 3 parts by weight of acetylene black as a conductive agent, 4 parts by weight of polyvinylidene fluoride (PVdF) as a binder and using N-methyl-pyrrolidone (NMP) as a dispersion medium is prepared. This paste is coated on one surface of 15 μm-thick aluminum foil as positive current collector 15 and dried and roll-pressed. Thus, mixture layer 14 is formed on one surface of positive current collector 15, followed by cutting in a size of 35 mm×35 mm. Finally, lead tab 18 is welded on the surface of positive current collector 15 at the side mixture layer 14 has not been formed. Thus, positive electrode 21 is produced. The weight per unit area of mixture layer 14 is adjusted based on the capacity per unit area of facing negative electrode 22. Specifically, the weight of the paste to be coated is adjusted so that the total of the discharge capacity at third cycle and sum of the irreversible capacity at first to third cycles in the model cell is equal to the same as the capacity of mixture layer 14.

In negative electrode 22, 31 μm-thick copper foil is used as negative electrode current collector 12 and active material layers 13 corresponding to first layer 5B and second layer 5C are formed on both surfaces of negative electrode current collector 12 by the same method as in the test electrode of the model cell. For example, in the case of Example 1, firstly, first layer 5B made of lithium is prepared on one side of the copper foil, and first layer 5B having the same thickness is prepared on the rear surface in the same conditions. Then, second layer 5C made of SiO is prepared on each of first layers 5B of both side. After each first layer 5B is formed on both surfaces in this way, each second layer 5C them is formed thereon so that active material layers 13 are formed on both surface of collector 5A, followed by cutting in the size of 37 mm×37 mm so as to obtain negative electrode 22. On a part of negative electrode current collector 12, active material layer 13 is not formed but lead tag 17 is attached on the part by welding.

Two of the thus produced positive electrodes 21 and negative electrode 22 are prepared and laminated via separator 16 so that positive electrode 21 sandwiches negative electrode 22. Separator is made of polypropylene fine porous film having a thickness of 25 μm. As this time, mixture layer 14 and active material layer 13 are disposed so that they are facing each other. Thus, electrode group 23 is constructed.

Next, electrode group 23 is vacuum dried at 60° C. for 12 hours, so that an amount of moisture in electrode group 23 is made to be not more than 50 ppm. The dried electrode group 23 is contained in bag 11 made of 50 μm-thick aluminum laminate. Then, an electrolyte solution having the same composition as that of the model cell is put into bag 11 and the inside pressure is reduced, and electrode group 23 is impregnated with the electrolyte solution. Thereafter, bag 11 is sealed so that lead tabs 17 and 18 are taken out to the outside at a modified polyethylene portion of the aluminum laminate. Thus, a battery is completed. The dimension of the produced battery is 40 mm in width and 40 mm in depth. Six batteries are produced for each example, respectively.

(vii) Evaluation of Batteries

Firstly, the battery is stored at 45° C. until the battery voltage become stable and reacts with lithium so as to be consumed. Next, the battery is transferred to an environment at an ambient temperature of 25° C. and constant-current charging is carried out at a current of 3 mA up to a voltage of 4.2 V. After halting for 30 minutes, constant-current discharging is carried out at a current of 3 mA to a voltage of 2.5 V. This charge/discharge cycle is repeated three times. This is called breaking-in charge/discharge.

The battery that has been subjected to the breaking-in charge/discharge is charged at a current of 3 mA up to 4.2 V in an environment at an ambient temperature of 25° C. In this state, the battery is placed in a polytetrafluoroethylene bag together with a pin and a known amount of argon gas is filled in the bag. Then, the bag is sealed. In the bag, hole is provided in the laminated portion of the battery by pushing the pin thereto, so that gas inside the battery is released. The amount of gas is calculated from the peak area ratio of the gas chromatography.

On the other hand, in an environment at 25° C., with respect to five batteries, 300 cycles of charge/discharge cycle tests are carried out. The value of the discharging capacity at the third cycle at the time of the breaking-in charge/discharge is regarded as the initial capacity. A current value corresponding to 1C (a current amount reaching the initial capacity for one hour) of this capacity is used as a current at the time of the cycle test and the constant-current charge and discharge is carried out. The charge end voltage and discharge end voltage are set to be 4.2 V and 2.5V, respectively similar to the breaking-in charge/discharge. The halting time between the charge and the discharge is set to be 30 minutes.

A capacity retention rate is calculated by dividing the discharge capacity at the 300th cycle by the discharge capacity of the first discharge in the battery that has undergone 300 cycles of charge/discharge cycles in this way, and the average value is calculated. The parameters and evaluation results of the batteries are shown in table 2.

TABLE 2

| | first layer | | second layer | | | |
|---|---|---|---|---|---|---|
| | | thickness | | thickness | amount of | capacity retention |
| | material | (μm) | material | (μm) | gas (μl) | rate (%) |
| Example 1 | Li | 6.5 | SiO | 10 | 37 | 83.4 |
| Comparative | — | — | SiO | 10 | 98 | 75.0 |
| Example 1 | | | | | | |
| Comparative | SiO | 10 | Li | 6.5 | 58 | 76.1 |
| Example 2 | | | | | | |

The amount of the gas generated after the breaking-in charge/discharge is particularly smaller in Example 1 and Comparative Example 2 than in Comparative Example 1. Since the thickness of SiO is the same in any batteries, it can be estimated that the difference in the amount of the generated gas is caused by the presence or absence of the lithium layer. Comparing Example 1 with Comparative Example 2, the amount of the generated gas is smaller in Example 1. In Comparative Example 2, a layer of the outermost surface of the negative electrode is metallic lithium and the reaction between this layer and the electrolyte solution occurs more easily as compared with the case where the lithium layer is covered with the SiO layer as in Example 1. Therefore, it is thought that the amount of the gas generated in Comparative Example 2 is larger. Thus, from the viewpoint of the amount of gas, it is effective that the surface of the lithium layer is covered with SiO as in Example 1.

Furthermore, the capacity retention rate is also more excellent in Example 1 than in Comparative Examples 1 and 2. In these three examples, since the thicknesses of SiO are the same, i.e. 10 μm at the beginning, it can be thought that the difference is caused by the presence or absence of the lithium layer and the location thereof.

Next, a case where the thicknesses of first layer 5B and second layer 5C are changed with the ratio of thickness of these layers kept constant is described. In Examples 2 to 5, model cells and a batteries are produced and evaluated in the same method as in Example 1 except that the thicknesses of the lithium layer as first layer 5B and the SiO layer as second layer 5C are changed by adjusting the vapor deposition time and the number of times of vapor deposition in production procedure of test electrode 5 in Example 1. The parameters and evaluation results of the model cells are shown in Table 3 and those of the batteries are shown in Table 4, respectively.

TABLE 3

| | | | | | charge/ | charge/discharge |
|---|---|---|---|---|---|---|
| | first layer | | second layer | | discharge | efficiency with |
| | | thickness | | thickness | efficiency | exposed negative |
| | material | (μm) | material | (μm) | (%) | electrode (%) |
| Example 2 | Li | 13 | SiO | 20 | 98.9 | 98.3 |
| Example 1 | Li | 6.5 | SiO | 10 | 98.9 | 98.5 |
| Example 3 | Li | 3.8 | SiO | 6 | 97.6 | 97.5 |
| Example 4 | Li | 1.8 | SiO | 3 | 95.4 | 95.2 |
| Example 5 | Li | 0.6 | SiO | 1 | 95.4 | 95.3 |

TABLE 4

| | first layer | | second layer | | | |
|---|---|---|---|---|---|---|
| | | thickness | | thickness | amount | capacity retention |
| | material | (μm) | material | (μm) | of gas (μl) | rate (%) |
| Example 2 | Li | 13 | SiO | 20 | 72 | 77.5 |
| Example 1 | Li | 6.5 | SiO | 10 | 37 | 83.4 |
| Example 3 | Li | 3.8 | SiO | 6 | 21 | 85.4 |
| Example 4 | Li | 1.8 | SiO | 3 | 12 | 88.3 |
| Example 5 | Li | 0.6 | SiO | 1 | 5 | 92.2 |

As is apparent from Table 3, regardless of the total thickness of first layer 5B and second layer 5C, these model cells show high charge/discharge efficiency. Furthermore, even if test electrode 5 is exposed to a high moisture environment, the charge/discharge efficiency is not deteriorated. Thus, even if the thickness of the SiO layer is 1 μm, the moisture resistant effect of test electrode 5 can be exhibited.

Furthermore, Table 4 shows that the amount of gas is substantially in proportion to the total thickness of first layer 5B and second layer 5C and that the amount of gas is in proportion to the amount of materials of the negative electrode. Furthermore, the capacity retention rate is larger as the thickness of the negative electrode material becomes smaller. This is thought to be because the absolute value of expansion and shrinkage of second layer 5C is smaller as the thickness is smaller.

Next, the case where the thicknesses of first layer 5B and second layer 5C are changed with the ratio of thickness of these layers kept constant and a carbon layer is further formed on second layer 5C is described.

In Examples 6 to 9, the thicknesses of the lithium layer as first layer 5B and the SiO layer as second layer 5C are changed by adjusting the vapor deposition time and the number of times of vapor deposition in the same procedure as that of test electrode 5 in Example 1. Then, a third layer formed of a carbon material is formed thereon by the following coating method. A paste is prepared by kneading 100 parts by weight of carbon materials capable of absorbing and desorbing lithium ions and 4 parts by solid weight of PVdF of NMP solution as a binder. This paste is coated on the SiO layer as second layer 5C, dried at 60° C. for eight hours and roll-pressed. The thickness of the carbon material layer is adjusted to 40 μm.

Model cells and batteries are produced and evaluated by the same method as in Example 1 except for the above procedure. In order to make a comparison with the model cells of these Examples, test electrode 5 having only second layer 5C and the third layer without having the lithium layer as first layer 5B is produced. By using these electrode, a model cell and a battery of Comparative Example 3 are produced and evaluated. The parameters and evaluation results of the model cells are shown in Table 5 and those of the batteries are shown in table 6, respectively.

TABLE 5

| | | | | | | | | charge/discharge |
|---|---|---|---|---|---|---|---|---|
| | first | | | | | | charge/ | efficiency with |
| | layer | | second layer | | third layer | | discharge | exposed |
| | | T** | | T** | | T** | efficiency | negative |
| | M* | (μm) | M* | (μm) | M* | (μm) | (%) | electrode (%) |
| Comparative | — | — | SiO | 10 | carbon | 40 | 72.7 | 72.3 |
| Example 3 | | | | | | | | |
| Example 6 | Li | 7 | SiO | 10 | carbon | 40 | 99.0 | 98.7 |
| Example 7 | Li | 10.7 | SiO | 16 | carbon | 40 | 98.4 | 98.2 |
| Example 8 | Li | 4.3 | SiO | 6 | carbon | 40 | 98.6 | 98.4 |
| Example 9 | Li | 1.6 | SiO | 2 | carbon | 40 | 96.9 | 96.8 |

M*: material,
T**: thickness

TABLE 6

| | first | | second | | | | | capacity |
|---|---|---|---|---|---|---|---|---|
| | layer | | layer | | third layer | | amount | reten- |
| | | T** | | T** | | T** | of gas | tion rate |
| | M* | (μm) | M* | (μm) | M* | (μm) | (μl) | (%) |
| Com- | — | — | SiO | 10 | carbon | 40 | 112 | 72.3 |
| parative | | | | | | | | |
| Example 3 | | | | | | | | |
| Example 6 | Li | 7 | SiO | 10 | carbon | 40 | 55 | 81.4 |
| Example 7 | Li | 10.7 | SiO | 16 | carbon | 40 | 74 | 78.2 |
| Example 8 | Li | 4.3 | SiO | 6 | carbon | 40 | 41 | 83.4 |
| Example 9 | Li | 1.6 | SiO | 2 | carbon | 40 | 24 | 84.7 |

M*: material,
T**: thickness

As is apparent from Tables 5 and 6, even in a case where the third layer made of a carbon material is further formed on second layer 5C, the same tendency is confirmed in Examples 1 to 5 and Comparative Example 1.

Next, a case where a Si layer or a SiTi₂—Si layer is formed on second layer 5C is described. In Examples 10 to 13, the thicknesses of the lithium layer as first layer 5B and the SiO layer as second layer 5C are changed by adjusting the vapor deposition time or the number of times of vapor deposition in the procedure for producing test electrode 5 in Example 1. Then, the Si layer is formed thereon as follows by the use of an electron beam vapor deposition device.

Copper foil on which the lithium layer and the SiO layer have been formed is set in the device. Then, an ingot of Si that is a raw material is irradiated with an electron beam in a vacuum, so that the surface of the ingot is melt-evaporated. Thus, a thin layer of Si is formed on the surface of the SiO layer. The acceleration voltage of electron beam is 8 kV to 10 kV, an emission current is 400 mA to 500 mA, and a vacuum degree in a chamber is set to 2×10⁻⁵ torr or less. A series of operations are repeated for a film formation time of 30 seconds, and then the amorphous Si layer having a thickness of 2 to 8 μm is formed.

Model cells and batteries are produced and evaluated by the same method as in Example 1 except for the above procedure. In order to make a comparison with these Examples, test electrode 5 having only second layer 5C and the third layer without having the lithium layer as first layer 5B is produced. By using these electrode, a model cell and a battery of Comparative Example 4 are produced and evaluated. Furthermore, test electrode 5 in which first layer 5B and second layer 5C have been replaced (changed) with each other is produced. Then, by using these electrode, a model cell and a battery of Comparative Example 5 are produced and evaluated. In this case, a layer of lithium that is an alkaline metal is not directly provided on current collector 5A.

In Examples 14 and 15, the thicknesses of the lithium layer as first layer 5B and the SiO layer as second layer 5C are changed by adjusting the vapor deposition time or the number of times of vapor deposition in the procedure for producing test electrode 5 in Example 1. Then, a SiTi₂—Si composite layer is formed thereon by using an electron beam vapor deposition device as follows.

Copper foil on which the lithium layer and the SiO layer have been formed is set in the device. Then, an ingot of Si and an ingot of Ti that are raw materials are irradiated with an electron beam in a vacuum, so that the surface of the ingots are melt-evaporated. Thus, a thin layer of SiTi₂—Si is formed on the surface of the SiO layer. An acceleration voltage of electron beam is 8 kV to 10 kV, an emission current is 300 mA to 450 mA, a vacuum degree in a chamber is kept to 2×10⁻⁵ torr or less. A series of operations are repeated for a film forming time of 30 seconds, and then a layer having a thickness of 6 μm or 10 μm is formed. An impure phase may be present or the surface of Si may be partially oxidized depending upon the conditions or methods for producing a layer, which do not matter in the effect of this embodiment.

Note here that the SiTi₂—Si layer is evaluated by the following method. For qualitative analysis of a phase included in the layer, a wide angle x-ray diffraction method is applied. By using a wide angle x-ray diffraction device with CuKα of wavelength of 1.5405 Å as a radiation source, the diffraction patterns in the range of the diffraction angle 2θ from 10° to 80° are measured. As a result, it is confirmed that two kinds or more of phases are present and that main peaks attributes to Si and SiTi₂. As a result, it is shown that principal components of this layer is a mixture of TiSi₂ and Si, that is an alloy.

Next, by an EPMA analysis of the cross section of the layer, a phase of an alloy containing Si is confirmed. The area ratio of the cross sectional area of the confirmed phase with respect to the entire cross section is calculated and this calculated value is defined as volume %. As a result, the content of the alloy containing Si in the layer is 65 volume %.

Model cells and batteries are produced and evaluated by the same method as in Example 1 except for the configurations of test electrode 5 and negative electrode 22. In order to make a comparison with these Examples, test electrode 5 having only second layer 5C and the third layer without having the lithium layer as first layer 5B is produced. By using these electrode, a model cell and a battery of Comparative Example 6 are produced and evaluated. Furthermore, test electrode 5 in which first layer 5B and second layer 5C have been replaced with each other is produced. Then, by using these electrode, a model cell and a battery of Comparative Example 7 are produced and evaluated. In this case, a layer of lithium that is an alkaline metal is not directly provided on current collector 5A. The parameters and evaluation results of the model cells are shown in Table 7 and those of the batteries are shown in table 8, respectively.

TABLE 7

| | | | | | | | | charge/discharge |
|---|---|---|---|---|---|---|---|---|
| | | | second | | | | charge/ | efficiency with |
| | first layer | | layer | | third layer | | discharge | exposed |
| | | T** | | T** | | T** | efficiency | negative |
| | M* | (μm) | M* | (μm) | M* | (μm) | (%) | electrode (%) |
| Comparative | — | — | SiO | 4 | Si | 6 | 84.3 | 84.0 |
| Example 4 | | | | | | | | |
| Example 10 | Li | 3.8 | SiO | 4 | Si | 6 | 98.7 | 98.5 |
| Comparative | SiO | 4 | Li | 3.8 | Si | 6 | 98.7 | 88.8 |
| Example 5 | | | | | | | | |
| Example 11 | Li | 6.8 | SiO | 10 | Si | 2 | 98.4 | 98.1 |
| Example 12 | Li | 1.7 | SiO | 1 | Si | 5 | 98.8 | 98.6 |
| Example 13 | Li | 2 | SiO | 0.5 | Si | 8 | 98.8 | 98.7 |
| Comparative | — | — | SiO | 2 | SiTi₂—Si | 10 | 81.1 | 80.8 |
| Example 6 | | | | | | | | |
| Example 14 | Li | 2.7 | SiO | 2 | SiTi₂—Si | 10 | 98.9 | 98.7 |
| Comparative | SiO | 2 | Li | 2.7 | SiTi₂—Si | 10 | 98.9 | 87.9 |
| Example 7 | | | | | | | | |
| Example 15 | Li | 4.0 | SiO | 5 | SiTi₂—Si | 6 | 98.2 | 98.0 |

M*: material,
T**: thickness

TABLE 8

| | first layer | | second layer | | third layer | | amount | capacity |
|---|---|---|---|---|---|---|---|---|
| | | T** | | T** | | T** | of gas | retention rate |
| | M* | (μm) | M* | (μm) | M* | (μm) | (μl) | (%) |
| Comparative | — | — | SiO | 4 | Si | 6 | 115 | 72.9 |
| Example 4 | | | | | | | | |
| Example 10 | Li | 3.8 | SiO | 4 | Si | 6 | 49 | 80.1 |
| Comparative | SiO | 4 | Li | 3.8 | Si | 6 | 59 | 73.1 |
| Example 5 | | | | | | | | |
| Example 11 | Li | 6.8 | SiO | 10 | Si | 2 | 48 | 81.7 |
| Example 12 | Li | 1.7 | SiO | 1 | Si | 5 | 31 | 83.0 |
| Example 13 | Li | 2 | SiO | 0.5 | Si | 8 | 62 | 98.7 |
| Comparative | — | — | SiO | 2 | SiTi₂—Si | 10 | 111 | 73.6 |
| Example 6 | | | | | | | | |
| Example 14 | Li | 2.7 | SiO | 2 | SiTi₂—Si | 10 | 44 | 81.9 |
| Comparative | SiO | 2 | Li | 2.7 | SiTi₂—Si | 10 | 49 | 74.1 |
| Example 7 | | | | | | | | |
| Example 15 | Li | 4.0 | SiO | 5 | SiTi₂—Si | 6 | 41 | 82.1 |

M*: material,
T**: thickness

In comparison between the results of Comparative Example 4 and Example 10 or comparison between the results of Comparative Example 6 and Example 14, the same tendency in Comparative Example 1 and Example 1 is observed. That is to say, by providing a lithium layer as first layer 5B between a SiO layer as second layer 5C and current collector 5A, the initial charge/discharge efficiency is improved and the charge/discharge cycle characteristics in battery are improved. The generation of gas is also suppressed. From the results of Comparative Example 5 or Comparative Example 7, it is thought that when the third layer is provided, the moisture resistance property of test electrode 5 is improved to some extent. Thus, in Comparative Example 5 and Comparative Example 7, the lithium layer is covered with some layer. In other words, the lithium layer is not completely exposed to the air. However, since a small amount of water is permeated and reactions occur, thus deteriorating the charge/discharge efficiency. Furthermore, the charge/discharge cycle characteristics are also more excellent in Example 10 and Example 14. From the above, it is preferable that the lithium layer as first layer 5B is provided between current collector 5A and second layer 5C.

In addition, from the results of Examples 10 to 13 or Examples 14 and 15, it is confirmed that the configuration is effective similar to Examples 2 to 5 even if the thicknesses of first layer 5B and second layer 5C are changed.

Next, a case where a Sn layer is formed on second layer 5C is described. In Examples 16 to 18, the thicknesses of the lithium layer as first layer 5B and the SiO layer as second layer 5C are changed by adjusting the vapor deposition time or the number of times of vapor deposition in the production procedure for test electrode 5 in Example 1. Then, a Sn layer is formed as follows thereon by the use of an electron beam vapor deposition device.

Copper foil on which a lithium layer and a SiO layer have been formed is set in a vacuum heating vapor deposition device. In a state in which the vacuum degree is set to 1×10⁻⁴ torr or less, Sn powder is subjected to vapor deposition several times at a vapor deposition rate of 0.6 to 1.5 nm/sec and for a continuous vapor deposition time of 30 minutes to one hour until the film thickness reaches 3 to 8 μm by adjusting the vapor deposition time and the number of times of vapor deposition. Thus, the Sn layer as a third layer is formed.

Model cells and batteries are produced and evaluated by the same method as in Example 1 except for the above procedure. In order to make a comparison with these Examples, test electrode 5 having only second layer 5C and the third layer without having the lithium layer as first layer 5B is produced. By using these electrode, a model cell and a battery of Comparative Example 8 are produced and evaluated. Furthermore, test electrode 5 in which first layer 5B and second layer 5C had been replaced with each other is produced. Then, by using these electrode, a model cell and a battery of Comparative Example 9 are produced and evaluated. In this case, a layer of lithium that is an alkaline metal is not directly provided on current collector 5A. The parameters and evaluation results of the model cells are shown in Table 9 and those of the batteries are shown in table 10, respectively.

TABLE 9

| | | | | | | | | charge/discharge |
|---|---|---|---|---|---|---|---|---|
| | | | | | | | charge/ | efficiency with |
| | first layer | | second layer | | third layer | | discharge | exposed |
| | | T** | | T** | | T** | efficiency | negative |
| | M* | (μm) | M* | (μm) | M* | (μm) | (%) | electrode (%) |
| Comparative | — | — | SiO | 1 | Sn | 8 | 80.6 | 80.5 |
| Example 8 | | | | | | | | |
| Example 16 | Li | 3.5 | SiO | 1 | Sn | 8 | 98.8 | 98.5 |
| Comparative | SiO | 1 | Li | 3.5 | Sn | 8 | 98.8 | 88.2 |
| Example 9 | | | | | | | | |
| Example 17 | Li | 2.7 | SiO | 2 | Sn | 4 | 98.9 | 98.7 |
| Example 18 | Li | 3.0 | SiO | 3 | Sn | 3 | 98.5 | 98.3 |

M*: material,
T**: thickness

TABLE 10

| | | | | | | | | capacity |
|---|---|---|---|---|---|---|---|---|
| | | | second | | | | | re- |
| | first layer | | layer | | third layer | | amount | tention |
| | | T** | | T** | | T** | of gas | rate |
| | M* | (μm) | M* | (μm) | M* | (μm) | (μl) | (%) |
| Comparative | — | — | SiO | 1 | Sn | 8 | 142 | 69.5 |
| Example 8 | | | | | | | | |
| Example 16 | Li | 3.5 | SiO | 1 | Sn | 8 | 54 | 79.7 |
| Comparative | SiO | 1 | Li | 3.5 | Sn | 8 | 56 | 77.7 |
| Example 9 | | | | | | | | |
| Example 17 | Li | 2.7 | SiO | 2 | Sn | 4 | 32 | 83.0 |
| Example 18 | Li | 3.0 | SiO | 3 | Sn | 3 | 29 | 83.4 |

M*: material,
T**: thickness

Tables 9 and 10 show that even when the Sn layer is formed as the third layer, the substantially the same tendency is shown as in the case where the Si layer or the SiTi₂—Si layer is provided.

Next, a case where as second layer 5C, a SnO layer is formed instead of the SiO layer is described. In Example 19, the lithium layer as a first layer 5B is formed on copper foil as current collector 5A, and on the lithium layer, a SnO layer is formed as follows.

Copper foil on which the lithium layer has been formed is set in a vacuum heating vapor deposition device. In a state in which the vacuum degree inside the chamber is set to 1×10⁻⁴ torr or less, SnO powder is subjected to vapor deposition several times at vapor deposition rate of 0.6 to 1.2 nm/sec and for a continuous vapor deposition time of 30 minutes to one hour until the film thickness reaches 8 μm by adjusting the vapor deposition time and the number of times of vapor deposition. Thus, the SnO layer as second layer 5C is formed.

The thus produced SnO layer is amorphous. The number of oxygen (x) of SnOₓ need not be exactly one. The number is changed depending upon the conditions for producing a layer and a device. Furthermore, an impure phase may be present or a minor amount of Sn or SnO₂ may be mixed depending upon the conditions or methods for producing the layer, which do not matter in the effect of this embodiment.

A model cell and a battery are produced by the same method as in Example 1 except that the thus produced test electrode 5 and negative electrode 22 are used. In order to make a comparison with Example 19, test electrode 5 having only second layer 5C and the third layer without having the lithium layer as first layer 5B is produced. By using these electrode, a model cell and a battery of Comparative Example 10 are produced and evaluated. Furthermore, test electrode 5 in which first layer 5B and second layer 5C had been replaced with each other is produced. Then, by using these electrode, a model cell and a battery of Comparative Example 11 are produced and evaluated. The parameters and evaluation results of the model cells are shown in Table 11 and those of the batteries are shown in table 12, respectively.

TABLE 11

| | | | | | | charge/discharge |
|---|---|---|---|---|---|---|
| | | | | | | efficiency with |
| | first layer | | second layer | | charge/discharge | exposed |
| | | thickness | | thickness | efficiency | negative |
| | material | (μm) | material | (μm) | (%) | electrode (%) |
| Example 19 | Li | 15 | SnO | 8 | 98.9 | 98.3 |
| Comparative | — | — | SnO | 8 | 50.3 | 50.0 |
| Example 10 | | | | | | |
| Comparative | SnO | 8 | Li | 15 | 51 | — |
| Example 11 | | | | | | |

TABLE 12

| | first layer | | | | | capacity |
|---|---|---|---|---|---|---|
| | | thick- | second layer | | amount | retention |
| | | ness | | thickness | of gas | rate |
| | material | (μm) | material | (μm) | (μl) | (%) |
| Example 19 | Li | 15 | SnO | 8 | 32 | 81.2 |
| Comparative | — | — | SnO | 8 | 84 | 73.5 |
| Example 10 | | | | | | |
| Comparative | SnO | 8 | Li | 15 | 51 | 73.7 |
| Example 11 | | | | | | |

Tables 11 and 12 show that when SnO is used for second layer 5C, substantially the same result as in the case where a SiO layer is provided is obtained.

Next, similar to the case where SiO is used for second layer 5B, a case where the thicknesses of the lithium layer as first layer 5B and the SnO layer as second layer 5C are changed and a case where a carbon material layer, a Si layer, a Sn layer or a SiTi₂—Si layer is formed on the SnO layer are described.

The way of adjusting the thickness of the lithium layer or the SnO layer is the same as those in Examples 2 to 5. Since methods of forming the carbon material layer, the Si layer, the Sn layer or the SiTi₂—Si layer are the same as in Examples 6, 10, 16, and 14, detailed description thereof is omitted herein.

Model cells and batteries are produced and evaluated by the same method as in Example 1 except for the above procedure. The parameters and evaluation results of the model cells are shown in Table 13 and those of the batteries are shown in table 14, respectively.

TABLE 13

| | first | | second | | | | charge/ | charge/discharge |
|---|---|---|---|---|---|---|---|---|
| | layer | | layer | | third layer | | discharge | efficiency with |
| | | T** | | T** | | T** | efficiency | exposed negative |
| | M* | (μm) | M* | (μm) | M* | (μm) | (%) | electrode (%) |
| Example 20 | Li | 22 | SnO | 12 | — | — | 95.3 | 94.6 |
| Example 21 | Li | 9.2 | SnO | 5 | — | — | 97.4 | 97.0 |
| Example 22 | Li | 3.7 | SnO | 2 | — | — | 97.5 | 97.3 |
| Example 23 | Li | 8.0 | SnO | 4 | carbon | 40 | 98.9 | 98.4 |
| Example 24 | Li | 4.5 | SnO | 2 | Si | 4 | 98.4 | 98.1 |
| Example 25 | Li | 5.1 | SnO | 2 | Sn | 4 | 98.3 | 98.0 |
| Example 26 | Li | 8.8 | SnO | 4 | SiTi₂—Si | 10 | 98.5 | 98.1 |

M*: material,
T**: thickness

TABLE 14

| | first | | second | | | | | capacity |
|---|---|---|---|---|---|---|---|---|
| | layer | | layer | | third layer | | | retention |
| | | T** | | T** | | T** | amount of gas | rate |
| | M* | (μm) | M* | (μm) | M* | (μm) | (μl) | (%) |
| Example 20 | Li | 22 | SnO | 12 | — | — | 48 | 79.0 |
| Example 21 | Li | 9.2 | SnO | 5 | — | — | 22 | 83.9 |
| Example 22 | Li | 3.7 | SnO | 2 | — | — | 10 | 86.2 |
| Example 23 | Li | 8.0 | SnO | 4 | carbon | 40 | 38 | 81.7 |
| Example 24 | Li | 4.5 | SnO | 2 | Si | 4 | 34 | 81.2 |
| Example 25 | Li | 5.1 | SnO | 2 | Sn | 4 | 37 | 79.3 |
| Example 26 | Li | 8.8 | SnO | 4 | SiTi₂—Si | 10 | 56 | 98.1 |

M*: material,
T**: thickness

The results of Tables 13 and 14 show that in the case where the SnO layer is formed as second layer 5C, similar to the case of the SiO layer, regardless of the thickness, the charge/discharge efficiency, resistance property of test electrode 5 against moisture and the charge/discharge cycle characteristics are improved. It is confirmed that the same advantages is obtained when a layer of a carbon material, Si, Sn, or SiTi₂—Si is formed as the third layer.

Next, a case where an alkaline metal or an alkaline earth metal other than lithium is used for first layer 5A is described. Firstly, a case where SiO is formed as second layer 5C is described.

In Examples 27, 30, 33, 36, 39 and 42, firstly, copper foil is set in a vacuum heating vapor deposition device. Vapor deposition is carried out in the same conditions as in Example 1 by using potassium, sodium, magnesium, calcium, strontium or barium as a vapor deposition source instead of lithium. In Examples 28, 29, 31, 32, 34, 35, 37, 38, 40, 41, 43 and 44, by the same method as in the Example as mentioned above, a layer of a carbon material or a Si layer are formed on the SiO layer, that is second layer 5C. Model cells and batteries are produced by the same method as in Example 1 except for the above procedure. Furthermore, test electrode 5 in which first layer 5B and second layer 5C have been replaced with each other is produced. Then, by using these electrode, model cells and batteries of Comparative Examples 12 to 17 are produced and evaluated. The parameters and evaluation results of the model cells are shown in Table 15 and those of the batteries are shown in table 16, respectively.

TABLE 15

| | | | | | | | | charge/discharge |
|---|---|---|---|---|---|---|---|---|
| | | | second | | | | charge/ | efficiency with |
| | first layer | | layer | | third layer | | discharge | exposed |
| | | T** | | T** | | T** | efficiency | negative |
| | M* | (μm) | M* | (μm) | M* | (μm) | (%) | electrode (%) |
| Example 27 | K | 6.8 | SiO | 3 | — | — | 99.0 | 98.6 |
| Comparative | SiO | 3 | K | 6.8 | — | — | 98.9 | — |
| Example 12 | | | | | | | | |
| Example 28 | K | 6.7 | SiO | 2 | carbon | 50 | 98.8 | 98.5 |
| Example 29 | K | 6.9 | SiO | 2 | Si | 3 | 98.9 | 98.7 |
| Example 30 | Na | 3.5 | SiO | 3 | — | — | 98.2 | 97.8 |
| Comparative | SiO | 3 | Na | 3.5 | — | — | 98.2 | — |
| Example 13 | | | | | | | | |
| Example 31 | Na | 3.4 | SiO | 2 | carbon | 50 | 98.8 | 97.8 |
| Example 32 | Na | 7.2 | SiO | 4 | Si | 6 | 99.1 | 98.9 |
| Example 33 | Mg | 3.5 | SiO | 10 | — | — | 99.0 | 98.4 |
| Comparative | SiO | 10 | Mg | 3.5 | — | — | 98.2 | — |
| Example 14 | | | | | | | | |
| Example 34 | Mg | 1 | SiO | 2 | carbon | 50 | 98.7 | 98.6 |
| Example 35 | Mg | 2.1 | SiO | 4 | Si | 6 | 99.1 | 99.0 |
| Example 36 | Ca | 6.5 | SiO | 10 | — | — | 98.9 | 98.5 |
| Comparative | SiO | 10 | Ca | 6.5 | — | — | 98.9 | — |
| Example 15 | | | | | | | | |
| Example 37 | Ca | 1.8 | SiO | 2 | carbon | 50 | 98.1 | 97.8 |
| Example 38 | Ca | 3.9 | SiO | 4 | Si | 6 | 98.9 | 98.5 |
| Example 39 | Sr | 8.4 | SiO | 10 | — | — | 98.9 | 98.4 |
| Comparative | SiO | 10 | Sr | 8.4 | — | — | 98.9 | — |
| Example 16 | | | | | | | | |
| Example 40 | Sr | 2.4 | SiO | 2 | carbon | 50 | 96.9 | 96.7 |
| Example 41 | Sr | 5.1 | SiO | 4 | Si | 6 | 98.8 | 98.4 |
| Example 42 | Ba | 9.8 | SiO | 10 | — | — | 99.0 | 98.4 |
| Comparative | SiO | 10 | Ba | 9.8 | — | — | 99.0 | — |
| Example 17 | | | | | | | | |
| Example 43 | Ba | 2.8 | SiO | 5 | carbon | 50 | 98.6 | 98.5 |
| Example 44 | Ba | 5.9 | SiO | 4 | Si | 6 | 99.0 | 98.7 |

M*: material,
T**: thickness

TABLE 16

| | | | second | | | | | |
|---|---|---|---|---|---|---|---|---|
| | first layer | | layer | | third layer | | | capacity |
| | | T** | | T** | | T** | amount of gas | retention rate |
| | M* | (μm) | M* | (μm) | M* | (μm) | (μl) | (%) |
| Example 27 | K | 6.8 | SiO | 3 | — | — | 14 | 85.9 |
| Comparative | SiO | 3 | K | 6.8 | — | — | 21 | 76.5 |
| Example 12 | | | | | | | | |
| Example 28 | K | 6.7 | SiO | 2 | carbon | 50 | 39 | 83.3 |
| Example 29 | K | 6.9 | SiO | 2 | Si | 3 | 29 | 81.4 |
| Example 30 | Na | 3.5 | SiO | 3 | — | — | 12 | 86.4 |
| Comparative | SiO | 3 | Na | 3.5 | — | — | 18 | 76.7 |
| Example 13 | | | | | | | | |
| Example 31 | Na | 3.4 | SiO | 2 | carbon | 50 | 35 | 84.0 |
| Example 32 | Na | 7.2 | SiO | 4 | Si | 6 | 52 | 79.1 |
| Example 33 | Mg | 3.5 | SiO | 10 | — | — | 41 | 82.1 |
| Comparative | SiO | 10 | Mg | 3.5 | — | — | 65 | 75.2 |
| Example 14 | | | | | | | | |
| Example 34 | Mg | 1 | SiO | 2 | carbon | 50 | 37 | 84.2 |
| Example 35 | Mg | 2.1 | SiO | 4 | Si | 6 | 55 | 80.4 |
| Example 36 | Ca | 6.5 | SiO | 10 | — | — | 42 | 81.8 |
| Comparative | SiO | 10 | Ca | 6.5 | — | — | 68 | 75.1 |
| Example 15 | | | | | | | | |
| Example 37 | Ca | 1.8 | SiO | 2 | carbon | 50 | 38 | 83.4 |
| Example 38 | Ca | 3.9 | SiO | 4 | Si | 6 | 57 | 79.3 |
| Example 39 | Sr | 8.4 | SiO | 10 | — | — | 46 | 79.3 |
| Comparative | SiO | 10 | Sr | 8.4 | — | — | 72 | 75.3 |
| Example 16 | | | | | | | | |
| Example 40 | Sr | 2.4 | SiO | 2 | carbon | 50 | 41 | 82.4 |
| Example 41 | Sr | 5.1 | SiO | 4 | Si | 6 | 63 | 78.3 |
| Example 42 | Ba | 9.8 | SiO | 10 | — | — | 48 | 78.2 |
| Comparative | SiO | 10 | Ba | 9.8 | — | — | 75 | 75.2 |
| Example 17 | | | | | | | | |
| Example 43 | Ba | 2.8 | SiO | 5 | carbon | 50 | 58 | 81.3 |
| Example 44 | Ba | 5.9 | SiO | 4 | Si | 6 | 64 | 78.7 |

M*: material,
T**: thickness

Tables 15 and 16 show that even when potassium, sodium, magnesium, calcium, strontium or barium is used for first layer 5B, the same result can be obtained as in the case where lithium is used for first layer 5B.

Furthermore, in Examples 45 to 62, a SnO layer is formed instated of the SiO layer as second layer 5C in Examples 27 to 44. Model cells and batteries are produced and evaluated by the same method as in Example 1 except for the above procedure. The parameters and evaluation results of the model cells are shown in Table 17 and those of the batteries are shown in table 18, respectively.

TABLE 17

| | | | | | | | | charge/discharge |
|---|---|---|---|---|---|---|---|---|
| | first | | second | | | | | efficiency with |
| | layer | | layer | | third layer | | charge/discharge | exposed |
| | | T** | | T** | | T** | efficiency | negative |
| | M* | (μm) | M* | (μm) | M* | (μm) | (%) | electrode (%) |
| Example 45 | K | 13.0 | SnO | 2 | — | — | 98.2 | 97.1 |
| Example 46 | K | 15.2 | SnO | 2 | carbon | 50 | 99.0 | 98.2 |
| Example 47 | K | 16.2 | SnO | 2 | Si | 4 | 99.0 | 98.1 |
| Example 48 | Na | 6.8 | SnO | 2 | — | — | 98.4 | 98.2 |
| Example 49 | Na | 7.9 | SnO | 2 | carbon | 50 | 98.9 | 98.5 |
| Example 50 | Na | 8.5 | SnO | 2 | Si | 4 | 98.7 | 98.3 |
| Example 51 | Mg | 8.0 | SnO | 8 | — | — | 98.3 | 97.8 |
| Example 52 | Mg | 5.3 | SnO | 5 | carbon | 50 | 98.4 | 98.1 |
| Example 53 | Mg | 2.5 | SnO | 2 | Si | 4 | 98.8 | 98.6 |
| Example 54 | Ca | 15.0 | SnO | 8 | — | — | 98.0 | 97.6 |
| Example 55 | Ca | 10.0 | SnO | 5 | carbon | 50 | 98.7 | 97.4 |
| Example 56 | Ca | 4.6 | SnO | 2 | Si | 4 | 98.9 | 98.5 |
| Example 57 | Sr | 19.2 | SnO | 8 | — | — | 97.8 | 97.1 |
| Example 58 | Sr | 5.5 | SnO | 5 | carbon | 50 | 98.2 | 97.9 |
| Example 59 | Sr | 4.6 | SnO | 2 | Si | 4 | 94.2 | 94.0 |
| Example 60 | Ba | 22.5 | SnO | 8 | — | — | 98.4 | 97.1 |
| Example 61 | Ba | 6.5 | SnO | 5 | carbon | 50 | 98.8 | 98.2 |
| Example 62 | Ba | 7.0 | SnO | 2 | Si | 4 | 99.1 | 98.5 |

M*: material,
T**: thickness

TABLE 18

| | first | | second | | | | | |
|---|---|---|---|---|---|---|---|---|
| | layer | | layer | | third layer | | | capacity |
| | | T** | | T** | | T** | amount of gas | retention rate |
| | M* | (μm) | M* | (μm) | M* | (μm) | (μl) | (%) |
| Example 45 | K | 13.0 | SnO | 2 | — | — | 11 | 84.8 |
| Example 46 | K | 15.2 | SnO | 2 | carbon | 50 | 39 | 81.4 |
| Example 47 | K | 16.2 | SnO | 2 | Si | 4 | 38 | 80.8 |
| Example 48 | Na | 6.8 | SnO | 2 | — | — | 9 | 85.9 |
| Example 49 | Na | 7.9 | SnO | 2 | carbon | 50 | 35 | 82.2 |
| Example 50 | Na | 8.5 | SnO | 2 | Si | 4 | 34 | 81.5 |
| Example 51 | Mg | 8.0 | SnO | 8 | — | — | 35 | 80.7 |
| Example 52 | Mg | 5.3 | SnO | 5 | carbon | 50 | 51 | 80.3 |
| Example 53 | Mg | 2.5 | SnO | 2 | Si | 4 | 34 | 83.4 |
| Example 54 | Ca | 15.0 | SnO | 8 | — | — | 38 | 80.1 |
| Example 55 | Ca | 10.0 | SnO | 5 | carbon | 50 | 52 | 79.8 |
| Example 56 | Ca | 4.6 | SnO | 2 | Si | 4 | 35 | 82.6 |
| Example 57 | Sr | 19.2 | SnO | 8 | — | — | 42 | 79.5 |
| Example 58 | Sr | 5.5 | SnO | 5 | carbon | 50 | 57 | 78.0 |
| Example 59 | Sr | 4.6 | SnO | 2 | Si | 4 | 39 | 80.5 |
| Example 60 | Ba | 22.5 | SnO | 8 | — | — | 44 | 80.5 |
| Example 61 | Ba | 6.5 | SnO | 5 | carbon | 50 | 60 | 79.3 |
| Example 62 | Ba | 7.0 | SnO | 2 | Si | 4 | 42 | 80.6 |

M*: material,
T**: thickness

Tables 17 and 18 show that when potassium, sodium, magnesium, calcium, strontium or barium is used for first layer 5B and SnO is used for second layer 5C, the similar results can be obtained as in the case where lithium is used for first layer 5B and SiO is used for first layer 5C.

In order to make a comparison with the above-mentioned Examples, instead of providing the lithium layer as first layer 5B, test electrode 5 and negative electrode 22 are produced as in Comparative Example 1 and Comparative Example 10. In the electrodes, the SiO layer or the SnO layer are formed on current collector 5A and a lithium foil is partially disposed on the SiO layer or the SnO layer Model cells and batteries of Comparative Examples 18 to 21 are produced and evaluated by the same method as in Example 1 except for the above procedure. In Comparative Examples 18 to 20, the thickness of the SiO layer is changed and accordingly the amount of lithium foil to be provided is changed. The parameters and evaluation results of the model cells are shown in Table 19 and those of the batteries are shown in table 20, respectively. Note here that the amount of lithium foil to be provided is shown by an amount per area of the SiO layer or an amount per area of the SnO layer in the model cell.

TABLE 19

| | | | | | charge/ |
|---|---|---|---|---|---|
| | | | | | discharge |
| | | | | | efficiency |
| | | | Provided | charge/ | with exposed |
| | first layer | | Li foil | discharge | negative |
| | | thickness | amount | efficiency | electrode |
| | material | (μm) | (μl) | (%) | (%) |
| Comparative | SiO | 10 | 0.73 | 96.5 | 65.8 |
| Example 18 | | | | | |
| Comparative | SiO | 6 | 0.44 | 96.9 | 66.2 |
| Example 19 | | | | | |
| Comparative | SiO | 3 | 0.22 | 97.3 | 67.4 |
| Example 20 | | | | | |
| Comparative | SnO | 8 | 1.69 | 96.3 | 50.4 |
| Example 21 | | | | | |

TABLE 20

| | | | Provided | | |
|---|---|---|---|---|---|
| | first layer | | Li foil | amount | capacity |
| | | thickness | amount | of gas | retention rate |
| | material | (μm) | (μl) | (μl) | (%) |
| Comparative | SiO | 10 | 0.73 | 76 | 75.3 |
| Example 18 | | | | | |
| Comparative | SiO | 6 | 0.44 | 45 | 75.4 |
| Example 19 | | | | | |
| Comparative | SiO | 3 | 0.22 | 27 | 75.2 |
| Example 20 | | | | | |
| Comparative | SnO | 8 | 1.69 | 68 | 73.7 |
| Example 21 | | | | | |

As shown in Tables 19 and 20, the initial charge/discharge efficiency and decrement in the amount of gas to be generated up to the third cycle are relatively excellent. However, the capacity retention rate after 300 cycles in the battery does not show the effect. This is thought to be because, for example, the SiO layer or the SnO layer dose not store lithium ions uniformly, so that uneven expansion is generated.

As mentioned above, in the negative electrode of the present embodiment, a first layer made of an alkaline metal or an alkaline earth metal is provided on a current collector, and a second layer of an active material capable of absorbing and desorbing lithium ions and blocking ingress of gas are provided on the first layer. Therefore, in a battery using this negative electrode, the first layer reduces the irreversible capacity and improves the initial charge/discharge efficiency. Furthermore, even if the negative electrode is exposed to the air, the first layer is not denatured. In addition, an amount of gas generated at the initial charge is reduced and the charge/discharge cycle characteristic is improved. The charge/discharge efficiencies of Examples 1 to 62 can be improved by appropriately adjusting the amount of an alkaline metal or an alkaline earth metal.

Note here that in the above-mentioned Examples, experiments are carried out in the same configuration while changing the thickness of each layer. However, all of the experiment results are shown to have the same advantages. In other words, even if a layer having the thickness other than those described in the Examples is formed, the same advantage can be achieved.

Note here that the case where the active material of positive electrode 21 is LiCoO₂ is described. However, the active material is not limited thereto. It is possible to use lithium nickelate (LiNiO₂), lithium manganate (LiMn₂O₄) and two kinds or more of a mixture of them and a mixture with LiCoO₂ or a solid solution including such transition metals, for example, LiCoₓNi_{y}Mn_{z}O₂ or Li(CoₐNi_{b}Mn_{c})₂O₄, and the like.

A non-aqueous electrolyte secondary battery using a negative electrode for non-aqueous electrolyte secondary battery of the present invention is useful for a power source of portable equipment such as a portable telephone.

What is claimed is:

1. A negative electrode for a non-aqueous electrolyte secondary battery, comprising:
a current collector;
a first layer provided on the current collector and including at least any one of alkaline metals and alkaline earth metals; and
a second layer provided on the first layer, the second layer including an active material capable of absorbing and desorbing lithium ions and having a barrier function of blocking ingress of gas.

2. The negative electrode according to claim 1, wherein the second layer comprises at least any one of an elementary substance and a compound of Group 13, 14, and 15 elements in a periodic table.

3. The negative electrode according to claim 2, wherein the second layer comprise at least one of silicon and tin.

4. The negative electrode according to claim 3, wherein the second layer comprises silicon and oxygen, and an atom ratio of oxygen in the active material is smaller than an atom ratio of silicon.

5. A non-aqueous electrolyte secondary battery, comprising:
a negative electrode having:
a current collector;
a first layer provided on the current collector and including at least any one of alkaline metals and alkaline earth metals; and
a second layer provided on the first layer, the second layer including an active material capable of absorbing and desorbing lithium ions and having a barrier function of blocking ingress of gas;
a positive electrode capable of absorbing and desorbing lithium ions; and
a non-aqueous electrolyte existing between the negative electrode and the positive electrode.

6. A method of manufacturing a negative electrode for a non-aqueous electrolyte secondary battery, the method comprising:
forming a first layer including at least any one of alkaline metals and alkaline earth metals on a current collector; and
forming a second layer on the first layer, the second layer including an active material capable of absorbing and desorbing lithium ions and having a barrier function of blocking ingress of gas.

7. The method according to claim 6, wherein forming a first layer and forming a second layer are carried out continuously in a way in which an oxidizing atmosphere is avoided.
